(19) United States
(12) Patent Application Publication
(10) Pub. No.: US 2024/0414061 A1
(43) Pub. Date: Dec. 12, 2024

(54) CONFLICT RESOLUTION BETWEEN GLOBAL AND LOCAL NETWORK MANAGERS IN A VIRTUALIZED COMPUTING SYSTEM

(71) Applicant: VMware, Inc., Palo Alto, CA (US)

(72) Inventors: Amarnath Palavalli, Fremont, CA (US); Suresh Muppala, Cupertino, CA (US); Sandesh Kumar Narappa Bheemanakone, Fremont, CA (US); Farzad Ghannadian, Burlingame, CA (US); Pavlush Margarian, Dublin, CA (US)

(21) Appl. No.: 18/330,143

(22) Filed: Jun. 6, 2023

(51) Int. Cl. H04L 41/0895; H04L 41/0894

(52) U.S. Cl. CPC H04L 41/0895; H04L 41/0894

(57) ABSTRACT

An example method of managing conflicts between a first inventory of a first manager and a second inventory of a second manager each managing entities in a computer system includes: receiving, at the first manager from the second manager, an update to be applied to the first inventory, the update comprising a first object, disposed in the second inventory, which applies a first policy to an entity in the computing system; detecting a conflict with a second object disposed in the first inventory, the second object applying a second policy to the entity; adding, in response to the conflict, the update to a buffer of the first manager; detecting a resolution of the conflict in the first inventory caused by the second object; and applying, in response to the resolution, the update from the buffer to the first inventory.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtualized infrastructure is carried out by virtualization software, which includes hypervisors installed in the host computers (“virtualized hosts”) and management software for managing the virtualized hosts. The management software can include a network manager for managing a software defined network (SDN) in the SDDC.

A user's computing system can include multiple SDDCs deployed in one or more computing environments, which include public cloud(s), on-premises data centers, co-location data centers, and the like. Each SDDC includes its own network manager and corresponding SDN. The user's computing system can include a global network manager that manages SDNs across the SDDCs. In such case, the network managers executing in the SDDCs become local network managers.

The global network manager can discover inventory objects representing SDN entities within individual SDDCs from local network managers. This enables the user to view and extend those inventory objects from the global network manager. Inventory changes to an SDDC made by the global network manager are pushed asynchronously to the local network manager to be realized in the SDDC. The global network manager and the local network managers are independent systems, each managing its own inventory. The asynchronous nature of discovering locally changed inventory objects at the global network manager, and globally changed inventory objects at the local network managers, can lead to inventory conflicts. For example, a user of the global network manager can create a policy persisted in the global inventory. Concurrently, another user of the local network manager can create the same policy persisted in the local inventory. This conflict in policies must be resolved between the global and local network managers.

### SUMMARY

In an embodiment, a method of managing conflicts between a first inventory of a first manager and a second inventory of a second manager is described. The first manager and the second manager manage entities in a computing system. The method includes receiving, at the first manager from the second manager, an update to be applied to the first inventory. The update comprises a first object, disposed in the second inventory, which applies a first policy to an entity in the computing system. The method includes detecting, by the first manager, a conflict with a second object disposed in the first inventory. The second object applies a second policy to the entity that conflicts with the first policy applied by the first object. The method includes adding, in response to the conflict, the update to a buffer of the first manager. The method includes detecting, by the first manager, a resolution of the conflict in the first inventory caused by the second object. The method includes applying, by the first manager in response to the resolution, the update from the buffer to the first inventory to represent, in the first inventory, that the first policy is applied to the entity.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram depicting a computing system according to embodiments.

FIG. 2 is a block diagram depicting a software-defined data center (SDDC) according to embodiments.

FIG. 3 is a block diagram depicting a logical relationship between a global network manger and a local network manager according to embodiments.

FIG. 4 is a block diagram depicting logical operation of a network manager processing an update from a remote network manager according to embodiments.

FIGS. 5A-5B are a flow diagram depicting a method of detecting inventory conflicts at a manager according to embodiments.

FIG. 6 is a flow diagram depicting a method of detecting actions that resolve sandboxed updates according to embodiments.

FIG. 7 is a flow diagram depicting a method of applying conflicting updates to a manager's inventory after conflict resolution according to embodiments.

FIG. 8 is a block diagram depicting a software-defined network (SDN) according to an example.

FIG. 9A is a block diagram depicting an object hierarchy in an inventory of a local network manager according to an example.

FIG. 9B is a block diagram depicting an object hierarchy in an inventory of a global network manager according to an example.

### DETAILED DESCRIPTION

Conflict resolution between global and local network managers in a virtualized computing system is described. In embodiments, the virtualized computing system comprises a software-defined data center (SDDC) having a software-defined network (SDN) configured therein. The local network manager executes in the SDDC and manages the SDN. The global network manager also manages the SDN and potentially one or more other SDNs in one or more other SDDCs. In embodiments, the global network manager executes in a public cloud, e.g., as a Software-as-a-Service (SaaS) in the public cloud. The local network manager maintains an inventory (“local inventory”) of objects representing SDN entities in its SDDC. Each object applies a policy to its SDN entity. For example, an object can represent a network address space to be applied to a logical switch. An object can represent a routing policy to be applied to a logical router. An object can represent a security policy that applies policy to one or more SDN entities, such as logical switches and logical routers. The global network manager maintains an inventory (“global inventory”) of objects representing policies to be applied to SDN entities across the SDDCs it manages. The global network manager and a local network manager asynchronously exchange inventory updates so that the global inventory and the local inventory are consistent. In this manner, the local inventory can include an object that applies a policy to an SDN entity in the SDDC and the global inventory can include another object that represents the same SDN entity and applies the same policy. A global user can interact with the global network manager to manage SDN entities at the global level (e.g., across SDDCs). A local user can interact with a local network manager to manage SDN entities at the SDDC level.

Due to the asynchronous nature of the updates passing between the global network manager and the local network manager, inventory conflicts can occur. An example inventory conflict includes the global user creating an object in the global inventory that applies a policy to an SDN entity in an SDDC, and a local user creating an object in the local inventory of the SDDC that applies another policy to the SDN entity. Both objects can be created before processing of the asynchronous updates by the global and local network managers, causing both objects to exist concurrently and apply different policies to the same SDN entity. Techniques are described herein where a network manager, such as a global network manager or a local network manager, detects and resolves conflicts between global and local inventories.

In embodiments, the techniques described herein include a network manager (global or local) receiving an update to be applied to its inventory from a remote network manager. The network manager can detect a conflict between the update, which includes an object that applies a policy to an SDN entity, and its inventory, which includes another object that applies another policy to the SDN entity. Upon detecting the conflict, the network manager does not apply the update to its inventory. Rather, the network manager holds the update in a buffer referred to herein as a “sandbox.” The network manager then generates an alarm requesting user action. The user can take an action in response to the alarm, such as removing the object from the inventory of the network manager. The network manager detects the resolution of the conflict (e.g., removal of the object from the network manager's inventory). In response to the resolution, the network manager removes the update from the sandbox and applies the update to its inventory. In this manner, the inventories of the network manager and the remote network manager become consistent. The conflict detection and resolution process can be performed in either the global network manager or the local network manager depending on which user (global user or local user) takes action to resolve the conflict. These and further aspects of the techniques for conflict detection and resolution are described below with respect to the drawings.

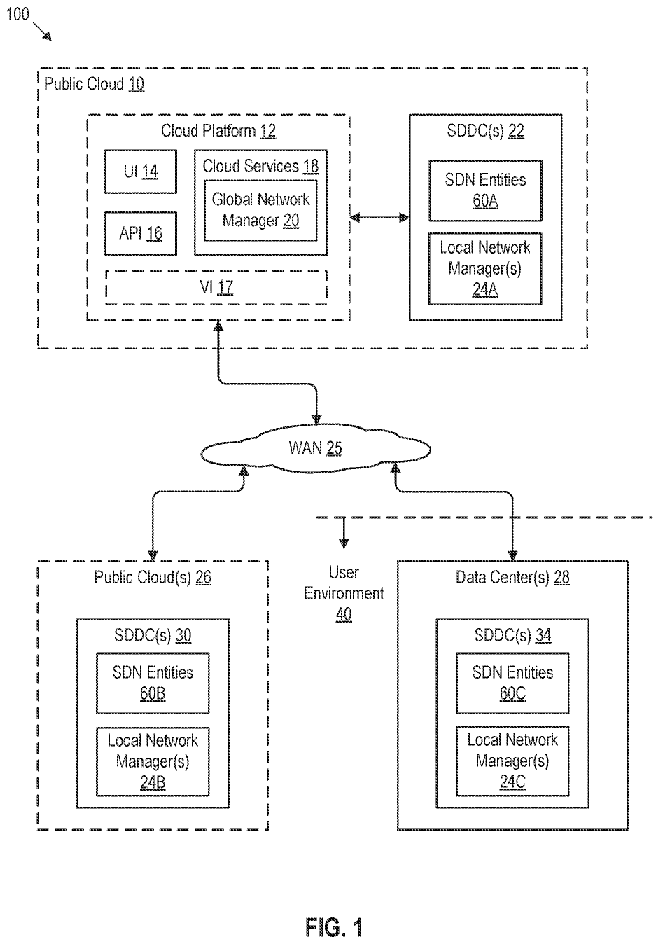

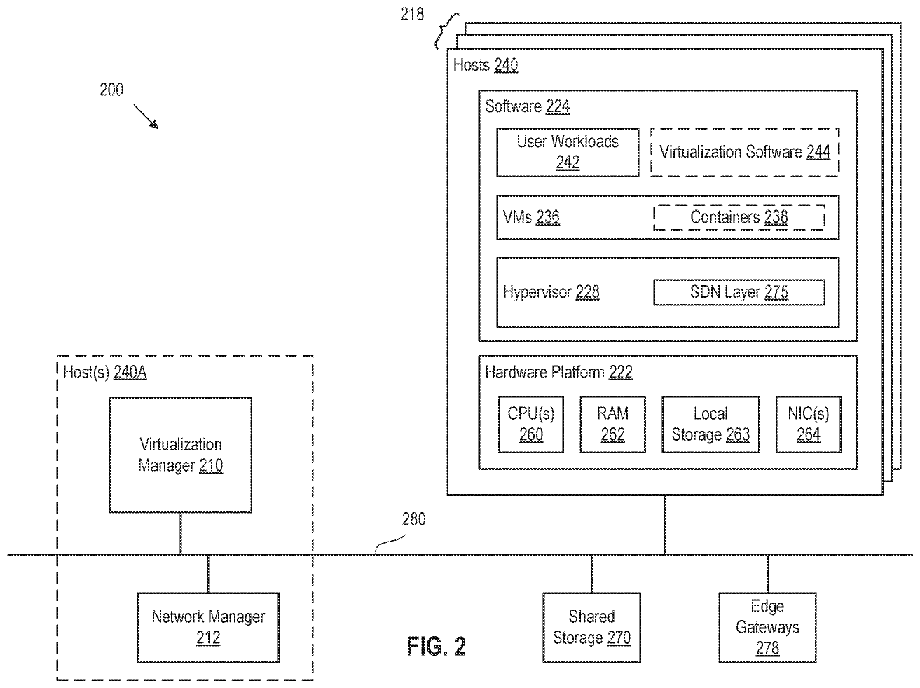

FIG. 1 is a block diagram depicting a computing system 100 according to embodiments. Computing system 100 comprises software executing on virtualized infrastructure disposed in one more cloud(s) and/or data center(s) (a “virtualized computing system”). Computing system 100 can be operated by a user, can include one or more SDDCs, and can be deployed in public cloud(s) and/or data center(s). In the example of FIG. 1, computing system 100 includes SDDC(s) 22 deployed in a public cloud 10, SDDC(s) 30 deployed in other public cloud(s) 26, and SDDC(s) 34 deployed in data center(s) 28 of a user environment 40. User environment 40 can include an on-premises environment, co-location environment, or the like. The user is a customer of public cloud 10 and public cloud(s) 26 (among other customers), where each can be operated by a different vendor. SDDC(s) 22, 26, and 28 are deployed on virtualized infrastructure (VI), which includes virtualized hosts (host computers having hypervisors installed thereon) and virtualization software (the hypervisors and management software). An example SDDC 200 deployed on VI is shown in FIG. 2 and described below. Components of computing system 100 deployed in different public cloud(s) and/or data center(s) communicate through a wide area network (WAN) 25, such as the public Internet.

Computing system 100 further comprises cloud services 18 executing on VI 17 in a cloud platform 12. Cloud services 18 include a global network manager service (“global network manager 20”). Cloud platform 12 can include a user interface (UI) 14 and/or application programming interface (API) 16. The user can interact with cloud services 18 through UI 14 and/or API 16. Other software can interact with cloud services 18 through API 16. In an embodiment, computing system 100 includes cloud services 18 each executing “as-a-service.” In such case, the vendor of public cloud 10 or another entity, such as a managed service provider, provides cloud services 18 to the user as SasS products. In another embodiment, computing system 100 includes cloud platform 12 as-a-service. In such case, the vendor of public cloud 10 or another entity (e.g., managed service provider) provides cloud platform 12 to the as an Infrastructure-as-a-Service (IaaS) product. Global network manager 20 comprises network management software that manages SDNs of computing system 100.

Each of SDDC(s) 22, 30, and 34 includes an SDN. An SDN comprises network control logic, executing as software-based controllers or APIs, that is decoupled from underlying physical network hardware (e.g., physical routers, physical switches, etc.). In an SDN, the network control plane and forwarding plane (the software) is decoupled from the data plane (the physical hardware). An SDN includes a plurality of SDN entities. An SDN entity comprises a software-defined network construct. Example SDN entities include logical switches, logical routers, logical load balancers, logical firewalls, security policies, domains, sub-networks, and the like, as well as collections of such network constructs (e.g., projects, sites, groups, etc.). The SDN in each SDDC is managed by local network management software referred to as a local network manager. Each local network manager is in communication with global network manager 20. In the example of FIG. 1, SDDC(s) 22 include SDN entities 60A managed by local network manger(s) 24A; SDDC(s) 30 include SDN entities 60B managed by local network manager(s) 24B; and SDDC(s) 34 include SDN entitles 60C managed by local network manager(s) 24C.

FIG. 2 is a block diagram depicting an SDDC 200 according to embodiments. SDDC 200 or variants thereof can be SDDC(s) 22, 30, 34. SDDC 200 or a variant thereof can also execute cloud services 18. SDDC 200 includes a cluster of hosts 240 (“host cluster 218”) that may be constructed on hardware platforms such as x86 architecture platforms or ARM platforms of physical servers. For purposes of clarity, only one host cluster 218 is shown. However, SDDC 200 can include many of such host clusters 218. As shown, a hardware platform 222 of each host 240 includes conventional components of a computing device, such as one or more central processing units (CPUs) 260, system memory (e.g., random access memory (RAM) 262), one or more network interface controllers (NICs) 264, and optionally local storage 263. CPUs 260 are configured to execute instructions, for example, executable instructions that perform one or more operations described herein, which may be stored in RAM 262. NICs 264 enable host 240 to communicate with other devices through a physical network 280. Physical network 280 enables communication between hosts 240 and between other components and hosts 240.

In the embodiment illustrated in FIG. 2, hosts 240 access shared storage 270 by using NICs 264 to connect to network 280. In another embodiment, each host 240 contains a host bus adapter (HBA) through which input/output operations (IOs) are sent to shared storage 270 over a separate network (e.g., a fibre channel (FC) network). Shared storage 270 include one or more storage arrays, such as a storage area network (SAN), network attached storage (NAS), or the like. Shared storage 270 may comprise magnetic disks, solid-state disks, flash memory, and the like as well as combinations thereof. In some embodiments, hosts 240 include local storage 263 (e.g., hard disk drives, solid-state drives, etc.). Local storage 263 in each host 240 can be aggregated and provisioned as part of a virtual SAN, which is another form of shared storage 270.

Software 224 of each host 240 provides a virtualization layer, referred to herein as a hypervisor 228, which directly executes on hardware platform 222. In an embodiment, there is no intervening software, such as a host operating system (OS), between hypervisor 228 and hardware platform 222. Thus, hypervisor 228 is a Type-1 hypervisor (also known as a “bare-metal” hypervisor). As a result, the virtualization layer in host cluster 218 (collectively hypervisors 228) is a bare-metal virtualization layer executing directly on host hardware platforms. Hypervisor 228 abstracts processor, memory, storage, and network resources of hardware platform 222 to provide a virtual machine execution space within which multiple virtual machines (VM) 236 may be concurrently instantiated and executed User workloads 242 execute in VMs 236 either directly on guest operating systems or using containers 238. Containers 238 implement operating system-level virtualization, wherein an abstraction layer is provided on top of a guest operating system in a VM 236. User workloads 242 comprise business applications, services, etc. deployed by the user.

The SDN of SDDC 200 includes an SDN layer 275 executing in hypervisors 228 of hosts 240. SDN layer 275 includes distributed software, such as distributed switches, distributed routers, etc. The SDN of SDDC 200 can further include virtualization software 244 executing in VM(s) 236, such as network control planes, service routers, etc. The SDN of SDDC 200 can further include edge gateways 278 that provide an interface between SDDC 200 and an external network (e.g., WAN 25). Edge gateways 278 can execute as virtualization software 244 on VM(s) or in separate hosts (not shown), which can be virtualized hosts or non-virtualized hosts.

A virtualization manager 210 manages host cluster 218 and hypervisors 228. Virtualization manager 210 installs agent(s) in hypervisor 228 to add a host 240 as a managed entity Virtualization manager 210 logically groups hosts 240 into host cluster 218 to provide cluster-level functions to hosts 240, such as VM migration between hosts 240 (e.g., for load balancing), distributed power management, dynamic VM placement according to affinity and anti-affinity rules, and high-availability. The number of hosts 240 in host cluster 218 may be one or many. Virtualization manager 210 can manage more than one host cluster 218. SDDC 200 can include more than one virtualization manager 210, each managing one or more host clusters 218.

SDDC 200 further includes a network manager 212. Network manager 212 manages the SDN of SDDC 200 Network manager 212 installs additional agents in hypervisor 228 to add a host 240 as a managed entity. Network manager 212 provides a management plane for SDN layer 275, SDN-related virtualization software 244, and edge gateways 278. In the context of SDDCs 22, 30, and 34 shown in FIG. 1, network manager 212 is a local network manager In embodiments, global network manager 20 executes in public cloud 10 as-a-service, e.g., as a SaaS product or IaaS product. In another embodiment, global network manager 20 can be a network manager 212 of an SDDC That is, a particular network manager 212 of an SDDC in computing system 100 can function as a global network manager and other network manager(s) 212 in other SDDC(s) can function as local network managers.

In embodiments, virtualization manager 210 and network manager 212 execute on hosts 240A, which are selected ones of hosts 240 and which form a management cluster Virtualization manager 210 and network manager 212 can execute in VMs 236 (with or without containers 238) on hosts 240A. In other embodiments, either or both of virtualization manager 210 and network manager 212 can execute on non-virtualized physical servers having operating systems installed therein rather than hypervisors. In other embodiments, either or both of virtualization manager 210 and network manager 212 can execute in host cluster 218, rather than a separate management cluster.

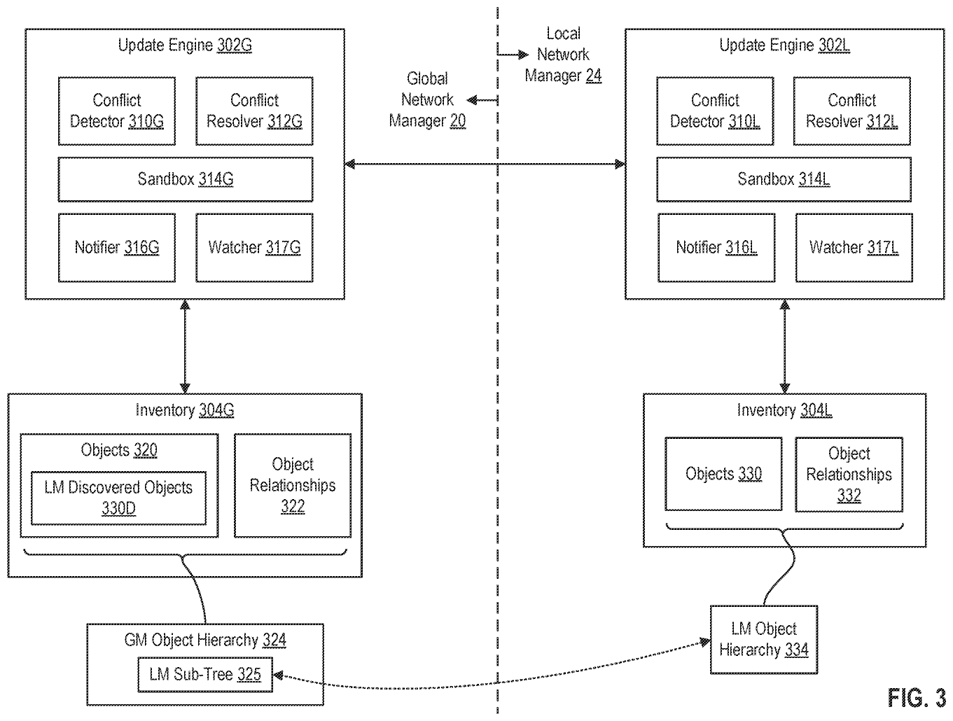

FIG. 3 is a block diagram depicting a logical relationship between a global network manger 20 and a local network manager 24 according to embodiments. Local network manager 24 can be any local network manager 24A, 24B, and 24C shown in computing system 100 of FIG. 1. Local network manager 24 can be implemented as a network manager 212 managing an SDN of an SDDC. Global network manager 20 can execute as-a-service (e.g., a SaaS or IaaS product) or as a network manager 212. If executing as a network manager 212, global network manager 20 can manage an SDN of an SDDC (a local network manager function) while performing its additional function of a global network manager that manages the multiple SDNs of computing system 100.

Local network manager 24 maintains an inventory 304L (referred to as a “local inventory”). Inventory 304L includes objects 330 and object relationships 332. An object 330 represents an SDN entity of the SDN in an SDDC having local network manager 24. An object 330 includes semantics (e.g., fields, properties, attributes, etc.) for its SDN entity. The semantics can include, among other information, identifiers for the SDN entity and a policy for the SDN entity that dictates behavior. Object relationships 332 include references between or among objects 330. An example object relationship 332 is a parent-child relationship. Objects 330 and object relationships 332 form a local manager (LM) hierarchy 334 in inventory 304L under a root object.

Global network manager 20 maintains an inventory 304G (referred to as a “global inventory”). Inventory 304G includes objects 320 and object relationships 332. Objects 320 1370 8 represents SDN entities of SDNs in computing system 100 (e.g., across SDDCs). Objects 320 can include those instantiated by a global user interacting with global network manager 20. For example, an object 320 can be a security policy defined by a global user applied to one or more SDDCs. Objects 320 also include LM discovered objects. LM discovered objects are objects 330 in local inventories that have been discovered by global network manager 20 through communication with local network managers. Thus, objects 320 include LM discovered objects 330D that are objects 330 discovered by global network manager 20 in inventory 304L from local network manager 24. An LM discovered object 330D in the global inventory, and an object 330 in a local inventory, refer to a common SDN entity. Object relationships 322 include references between or among objects 320 (e.g., parent-child relationships). Objects 320 and object relationships 322 form a global manager (GM) object hierarchy 324 under a root object. Through the discovery process, global network manager 20 learns LM object hierarchies in local inventories managed by local network managers across SDDCs. GM object hierarchy 324 includes a sub-tree for each discovered LM object hierarchy 334. Thus, GM object hierarchy 324 includes LM sub-tree 325 corresponding to LM object hierarchy 334 discovered by global network manager 20. An LM sub-tree comprises a portion of GM object hierarchy 324 and its objects can be descendants of higher-level objects in GM object hierarchy 324.

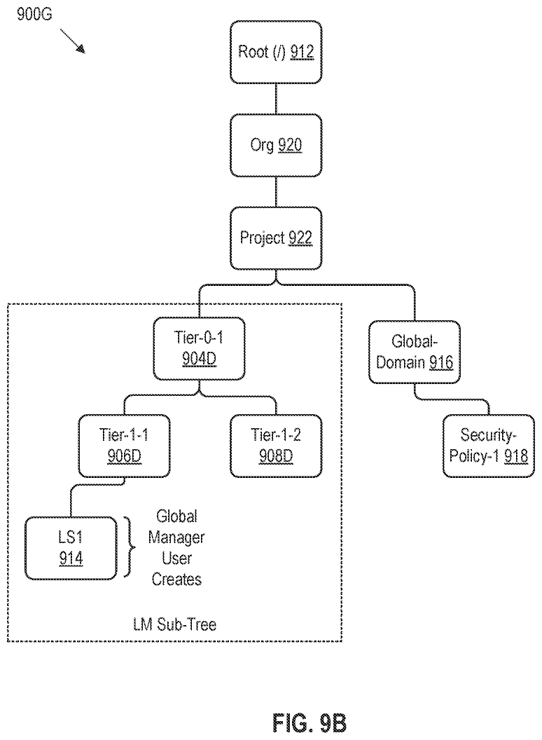

In various operations described herein, a network manager determines if an object in its inventory matches an object in a remote network manager's inventory. From the perspective of the SDN, matching objects between global and local inventories refer to the same SDN entity (whether intentional or unintentional). From an inventory perspective, matching objects have the same absolute paths or the same relative paths. Consider the example of FIGS. 9A-9B discussed further below, which show local and global inventories respectively. The object 910 (LS1) has an absolute path in the local inventory of /Tier-0-1/Tier-1-/LS1 (FIG. 9A). The object 914 (LS1) has an absolute path in the global inventory of /org/project/Tier-0-1/Tier-1-1/LS1 (FIG. 9B). In the global inventory, the object /org/project is the root of the LM sub-tree representing the local inventory under its root (/). Since root (/) in the local inventory becomes /org/project in the global inventory, the objects 910 and 914 have the same relative paths of . . . /Tier-0-1/Tier-1-1/LS1 and are considered to match one another.

Global network manager 20 and local network manager 24 are two independent systems. A global user interacts with global network manager 20 to manage the global inventory (inventory 304G). A local user interacts with local network manager 24 to manage the local inventory (inventory 304L). A global user can create, update, and delete objects 320 in inventory 304G, while a local user can create, update, and delete objects 330 in local inventory 304L. Global network manger 20 and local network managers exchange inventory updates (“updates”) so that the global inventory can be consistent with each local inventory. This means that a global user can have a full view of the SDN entities across SDNs of the SDDCs in computing system 100 and the corresponding local policies enforced on those SDN entities. A global user can also define global SDN entities that apply global policies to one or more SDNs of one or more SDDCs. The update exchange allows these global SDN entities to be persisted in local inventories so that they can be applied to corresponding SDN entities. In embodiments, global network manager 20 and local network managers exchange updates asynchronously. Thus, a global user can make changes to the global inventory and global network manager 20 can, independent of when such changes are made, batch and send updates for those changes to local network manager(s). A local user can make changes to a local inventory and a local network manager can, independent of when such changes are made, batch and send updates for those changes to global network manager 20. Global network manger 20 and local network manger 24 exchange updates without synchronization to when global/local inventory changes are made.

Global network manager 20 and the local network managers 20 include update engines to process updates, which includes conflict detection and conflict resolution that can occur due to the asynchronous nature of the updates. As shown in FIG. 3, global network manager 20 includes update engine 302G and local network manager 24 includes update engine 302L. Each update engine includes a conflict detector, a conflict resolver, a buffer referred to as a sandbox, a notifier, and a watcher. Thus, update engine 302G includes conflict detector 310G, conflict resolver 312G, sandbox 314G, notifier 316G, and watcher 317G. Update engine 302L includes conflict detector 310L, conflict resolver 312L, sandbox 314L, notifier 316L, and watcher 317L.

A notifier in an update engine is configured to send updates to selected network manager(s) and a watcher is configured to receive updates from selected network manager(s). In FIG. 3, notifier 316G sends updates made to the global inventory (inventory 304G) to each local manager in computing system 100 (e.g., local manager 24). Watcher 317L in local network manager 24 watches for and receives updates from notifier 316G in global network manager 20. Notifier 316L in local network manager 24 sends updates made to the local inventory (inventory 304L) to global network manager 20. Watcher 317G in global network manager 20 watches for and receives updates from notifier 316L in local network manager 24. Each update includes an inventory change. A notifier can batch send out updates independent of when such inventory changes are made. In general, each update batch from a notifier includes one or more updates.

A conflict detector is configured to determine whether an update will result in an inventory conflict. An inventory conflict can have various forms. One form of inventory conflict is an update that attempts to create an object that is already present in the inventory to which the update is being applied (“object creation conflict”). This can happen in the following example scenario: A global user creates an object 320 in inventory 304G representing an SDN entity. Before network manager 24 processes an update caused by the global user's inventory change, a local user creates an object 330 in inventory 304L representing the same SDN entity. Global network manager 20 and local network manager 24 then exchange updates for the respective global and local inventory changes of the new object representing the same SDN entity. In each network manager (global and local), there is an inventory conflict: the respective inventory includes an object applying one policy to the SDN entity and the update includes an object applying a potentially different policy to the SDN entity.

Another form of inventory conflict is an update that attempts to update semantics of an object from a first version to a second version, but the inventory includes the object with semantics at a version other than the first version (“object semantic update conflict”). This can happen example scenario: A local user updates semantics of an object 330 from version 1 to version 2. A global user updates semantics of an object 320, referring to the same SDN entity, from version 1 to version 3. The version updates occur before the network managers process each other's updates. In each network manager (global and local), there is an inventory conflict: at global network manager 20, the update intends a semantic update from version 1 to version 2, but the object has semantics at version 3. At local network manager 24, the update intends a semantic update from version 1 to version 3, but the object has semantics at version 2.

Another form of inventory conflict is an update for an object that itself does not cause an inventory conflict, but which is related to another object in the update or previous update that does cause an inventory conflict (“object relation conflict”). For example, a conflict detector can determine a parent object in an update causes an inventory conflict. The update can also include an action performed on a child object of the parent object. The child object by itself may not cause an inventory conflict, but is related to the parent object that does cause an inventory conflict. Since the child object is related to an inventory conflicting object, the child object is also deemed to be in conflict.

Conflict detector 310G processes updates, received by watcher 317G from notifier 316L of local network manager 24, and checks for inventory conflicts with respect to inventory 304G. Conflict detector 310L processes updates, received by watcher 317L from notifier 316G of global network manager 2, and checks for inventory conflicts with respect to inventory 304L.

A sandbox is configured to store, temporarily, updates that a conflict detector determines cause inventory conflicts (“conflicting updates”). Thus, when a conflict detector identifies a conflicting update, the conflict detector adds the conflicting update to the sandbox rather than applying the conflicting update to the inventory. A conflicting update is stored in the sandbox until resolved as determined by a conflict resolver. In the example of FIG. 3, conflict detector 310G adds conflicting updates to sandbox 314G, and conflict detector 310L adds conflicting updates to sandbox 314L.

A conflict resolver is configured to detect resolution of inventory conflicts in response to user action. A conflict detector can generate an alarm for each conflicting update it stores in a sandbox. A network manager can process alarms and present them to a user (e.g., through a UI or some other notification mechanism such as e-mail). The user can interact with the network manager to manage the inventory based on the alarm. In an embodiment, the user can respond to an alarm generated in response to an inventory conflict by deleting, renaming, or otherwise removing objects from the conflicting position in the object hierarchy, or alternatively updating semantics of object(s) in the object hierarchy. The conflict resolver detects inventory changes, such as object deletions, and determines if any inventory change resolves a conflict caused by a conflicting update in the sandbox. If so, the conflict resolver removes the conflicting update from the sandbox and then applies the update to the inventory.

In the example of FIG. 3, conflict resolver 312G monitors inventory changes (e.g., object deletions) in inventory 304G and attempts to resolve conflicting updates in sandbox 314G. Conflict resolver 312L monitors inventory changes (e.g., object deletions) in inventory 304L and attempts to resolve conflicting updates in sandbox 314L. Conflict resolver 312G removes conflicting updates from sandbox 314G that have been resolved. Conflict resolver 312L removes conflicting updates from sandbox 314L that have been resolved.

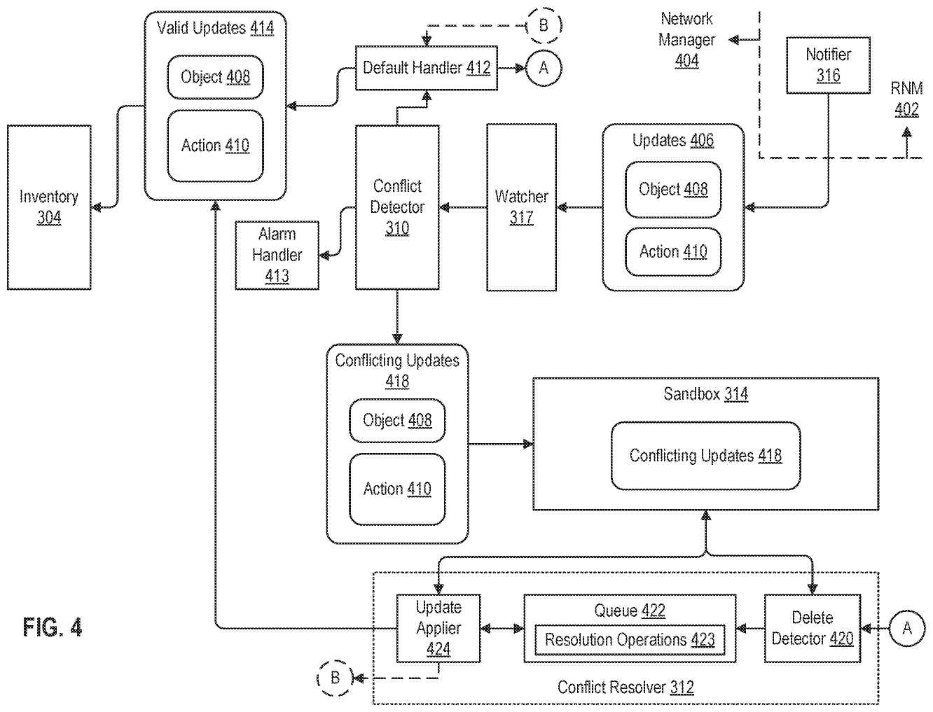

FIG. 4 is a block diagram depicting logical operation of a network manager processing an update from a remote network manager according to embodiments. In FIG. 4, a network manager 404 processes updates 406 output by a notifier 316 of a remote network manager 402. For example, network manager 404 can be a global network manager and remote network manager 402 can be a local network manager. In another example, network manager 404 can be a local network manager and remote network manager 402 can be a global network manager. Each update 406 sent by remote network manager 402 includes an object 408 and an action 410, which represent an inventory change at remote network manager 402. Network manager 404 watches for and receives updates 406 at watcher 317. Watcher 317 provides updates 406 to conflict detector 310. Watcher 317 can perform some operation(s) on updates 406, such as decompression, decryption, etc.

Conflict detector 310 determines if an update 406 causes a conflict in inventory 304. Inventory conflicts include object creation conflicts, object semantic update conflicts, and object relation conflicts, as described above. Conflict detector 310 adds conflicting updates 418 to sandbox 314. Each conflicting update 418 includes an object 408 and an action 410. Conflict detector 310 generates an alarm for each conflicting update 418 added to sandbox 314. Conflict detector 310 can provide alarms to alarm handler 413 of network manager 404. Alarm handler 413 is configured to present alarms to a user. Conflict detector 310 sends non-conflicting updates to default handler 412. Default handler 412 comprises logic of network manager 404 configure to manage objects in inventory 304, including creating objects, updating object semantics, and deleting objects. Default handler 412 applies valid updates 414 to inventory 304. Each valid update includes an object 408 and an action 410 to be applied to object 408 (e.g., create, update, delete).

Conflict resolver 312 includes delete detector 420, queue 422, and update applier 424. Delete detector 420 is configured to monitor for delete operations performed on inventory 304 by default handler 412. Delete detector 420 determines if a delete operation removes an object from inventory 304 that resolves a conflicting update 418. If so, delete detector 420 adds a resolution operation 423 to queue 422. Queue 422 can store one or more resolution operations 423. Update applier 424 dequeues resolution operations 423 from queue 422. Update applier 424 removes a conflicting update 418 from sandbox 314 for each resolution operation 423. In an embodiment, update applier 424 forms a valid update 414 from conflicting update 418 and applies valid update 414 to inventory 304. In another embodiment, update applier 424 can remove a conflicting update 418 from sandbox 314 for each resolution operation 423 and send a non-conflicting update to default handler 412 (rather than apply updates itself). Although not shown, in an embodiment, conflict detector 310 can also include an update applier to apply valid, non-conflicting updates to inventory 304 rather than sending them to default handler 412.

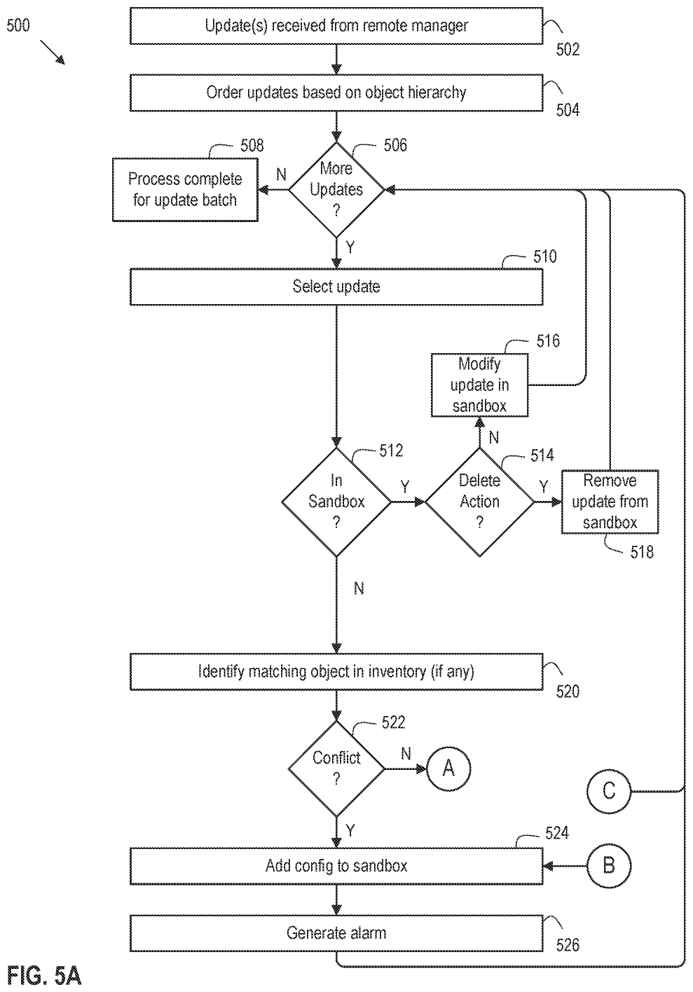

FIGS. 5A-5B are a flow diagram depicting a method 500 of detecting inventory conflicts at a manager according to embodiments. In an embodiment, the manager is a network manager that receives, from a remote network manager, updates to be applied to the inventory of the network manager after conflict checking and resolution. For example, the manager can be a global network manager processing updates from a local network manager. In another example, the manager can be a local network manager processing updates from a global network manager. With respect to the example of FIG. 4, method 500 is performed by conflict detector 310.

Embodiments for conflict detection and resolution are described above with respect to a global network manager that manages local network managers, where each network manager (global and local) maintains an inventory of SDN entities. It is to be understood, however, that the conflict detection and resolution techniques described herein can apply to other types of management software in a virtualized computing system. For example, in an embodiment, the manager described in FIGS. 5A-5B can be a virtualization manager. A virtualization manager manages an inventory of VI entities, such as VMs, hosts, clusters, resource pools, datastores, data centers, and the like. A virtualized computing system can include a global virtualization manager configured to manage local virtualization managers, where each virtualization manager (global and local) maintains an inventory of VI entities. The manager can be a global virtualization manager and the remote manager can be a local virtualization manager and vice versa. Thus, embodiments of the conflict detection and resolution process can be described with respect to a manager and a remote manager, where the manager can be a global manager (GM) and the remote manager can be a local manager (LM) and vice versa. For purposes of clarity by example, the embodiments of conflict detection and resolution are described with respect to network managers managing inventories of SDN entities (e.g., global network manager 20 and local network manager 24) or with respect to managers managing inventories of entities (e.g., GM and LM).

Method 500 begins at step 502, where the manager receives update(s) from the remote manager. For example, a batch of updates can include at least one update. At step 504, the manager orders the updates based on object hierarchy. Objects can include object relationships that establish an object hierarchy. The manager can receive the updates in any order, but at step 504 can order the updates based on the respective objects and the objects' position in the object hierarchy. In method 500, the manager processes each of the updates in iterative fashion. Thus, at step 506, the manager determines if there are more updates to process. If not, method 500 proceeds to step 508, where the manager completes processing the update batch for conflict detection. Otherwise, method 500 proceeds from step 506 to step 510.

At step 510, the manager selects an update to process for conflict detection (“selected update”). At step 512, the manager determines if the selected update matches an update in the sandbox. Object matching between manager inventories is discussed above. Referring to the example in FIG. 4, a conflicting update 418 in sandbox 314 can have an object 408 with a path “some-relative-path/segment-1” where segment-1 represents a logical switch. Later, remote network manger 402 can send another update 406 to network manager having an object 408 with a path “some-relative-path/segment-1.” The manager can determine if a selected update matches an update in the sandbox based on object paths. If at step 512 the selected update matches an update in the sandbox, method 500 proceeds to step 514.

At step 514, the manager determines if the selected update undoes a conflicting update in the sandbox. This indicates that the remote manger, in a second action, reversed a first action on the same object. If at step 514 the selected update undoes a conflicting update, method 500 proceeds to step 518, where the manager removes the matching conflicting update from the sandbox. If at step 514 the selected update does not undo a conflicting update in the sandbox, method 500 proceeds to step 516, where the manager modifies the conflicting update in the sandbox with the information in the selected update. For example, the selected update can include an object with different semantics than that in the conflicting update stored in the sandbox. Method 500 returns to step 506 from both steps 516 and 518.

The “yes” branch of step 512 can be triggered in the scenario where a user of the remote manager performs a second action on an object before the manager has had a chance to resolve a conflict caused by a first action on the same object. For example, a user of remote manager can add an object to its inventory. The remote manager sends an update for this action to the manager, which determines there is a conflict and adds the update to the sandbox. Before resolution of the conflicting update at the manager, the user of the remote manager can delete the object from its inventory. The remote manager sends another update for this delete action to the manager. The manager, at step 512, determines that this update for the delete action targets the same object as the update for the create action in the sandbox. Since the user has deleted the object at the remote inventory, the conflict has been resolved without intervention at the manager. Thus, the manager removes the update for the create action from the sandbox (step 518). There is another scenario where the second action is not a delete action, but rather a modify action (e.g., modifying the semantics of the object). In such case, method 500 proceeds to step 516, where the object for the first action has its semantics updated according to the modify action in the second action.

If at step 512 the selected update does not match an update in the sandbox, method 500 proceeds to step 520. At step 520, the manager identifies an object in its inventory that matches the object that is the subject of the selected update (if any). Object matching is discussed above. The object of the selected update may not exist in the manager's inventory (e.g., the user of the remote manager created the object and there was no corresponding create action by any user of the manager) and thus step 520 may return no object.

At step 522, the manager determines if the selected update conflicts with the manager's inventory. The inputs to the check at step 522 include the update and its object and optionally a matching object in the manager's inventory. Inventory conflicts checked at step 522 include object creation conflicts and object semantic update conflicts, as described above. If at step 522 a conflict is detected, method 500 proceeds to step 524. At step 524, the manager adds the update as a conflicting update to the sandbox. At step 526, the manager generates an alarm for the conflict. Method 500 returns to step 506 from step 526.

If at step 522 a conflict is not detected, method 500 proceeds to step 528. At step 528, the manager determines if the object in the selected update is related to any object(s) that are the subject(s) of conflicting update(s) in the sandbox. The manager checks for related object(s) using object paths or references in object semantics. For example, the object in an update can be a child object of a parent object in a conflicting update stored in the sandbox. In another example, the object in an update can be referred to by another object in a conflicting update stored in the sandbox. In another example, the object in an update can refer to another object in a conflicting update stored in the sandbox. In any scenario, the object is in conflict due to the relation with another conflicting object (object relation conflicts, as described above). If a relationship with a conflicting update is found, method 500 proceeds from step 530 to step 524, where the selected update is added as a conflicting update in the sandbox. If no relationship with a conflicting update is found, method 500 proceeds from step 530 to step 532. At step 532, the manager sends the update to its default handler for processing. Alternatively, method 500 can apply the update to the manager's inventory. Method 500 returns to step 506 from step 532.

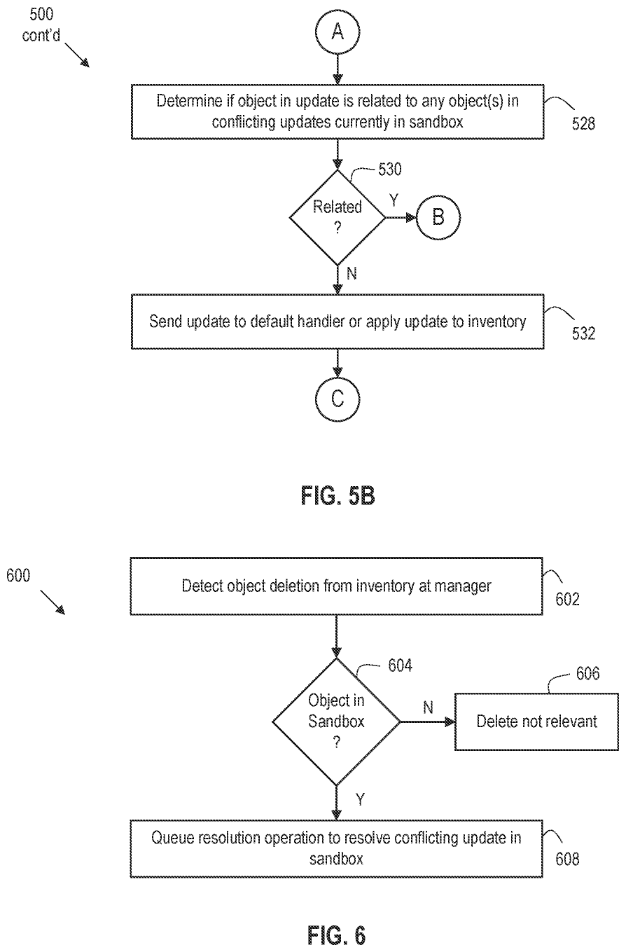

FIG. 6 is a flow diagram depicting a method 600 of detecting actions that resolve sandboxed updates according to embodiments. Similar to FIGS. 5A-5B, method 600 refers to a manager. An example manager is the global network manager or a local network manager. In the example of FIG. 4, method 600 is performed by delete detector 420 of conflict resolver 312.

Method 600 begins at step 602, where the manager detects object deletion from the manager's inventory. For example, a user of the manager can delete an object in response to an alarm generated by the manager indicating a conflicting update. At step 604, the manager determines if the deleted object matches the object in any conflicting update stored in the sandbox. Object matching is discussed above. If not, method 600 proceeds to step 606, where the delete operation is ignored by the conflict resolution process. Otherwise, method 600 proceeds from step 604 to step 608. At step 608, the manager queues a resolution operation to resolve the conflicting update in the sandbox. The manager can repeat method 600 for each detected object deletion from its inventory.

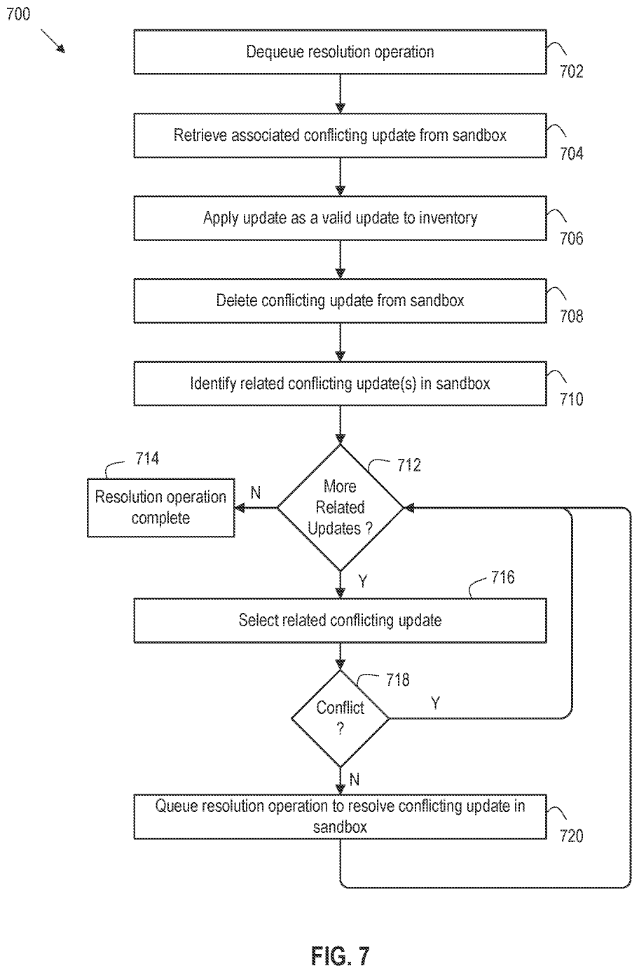

FIG. 7 is a flow diagram depicting a method 700 of applying conflicting updates to a manager's inventory after conflict resolution according to embodiments. Similar to FIGS. 5A-5B and 6, method 700 refers to a manager. An example manager is the global network manager or a local network manager. In the example of FIG. 4, method 700 is performed by update applier 424 of conflict resolver 312.

Method 700 begins at step 702, where the manager dequeues a resolution operation (as created by method 600 of FIG. 6). At step 704, the manager retrieves the associated conflicting update from the sandbox (e.g., the conflicting update identified in step 604). At step 706, the manager applies the conflicting update to the manager's inventory as a valid update. Alternatively, the manager can send the conflicting update as a non-conflicting update to a default handler of the manager, which handles the update. In any case, at step 708, the manager deletes the conflicting update from the sandbox.

At step 710, the manager identifies any related conflicting update in the sandbox for the conflicting update just processed. For example, the conflicting update processed above can be for a parent object and there can another conflicting update in the sandbox for its child object. If at step 712 there are no related conflicting updates, method 700 proceeds to step 714, where the resolution operation is completed. Otherwise, method 700 proceeds from step 712 to step 716. At step 716, the manager selects a related conflicting operation from the sandbox (“selected conflicting operation”). At step 718, the manager determines if the selected conflicting operation is still in conflict. Inventory conflicts checked at step 718 include object creation conflicts and object semantic update conflicts, as described above. If there is still a conflict, method 700 proceeds from step 718 to step 712. Otherwise, method 700 proceeds from step 718 to step 720, where the manager queues another resolution operation to resolve the selected conflicting update in the sandbox. The manger repeats method 700 as resolution operations are added to the queue.

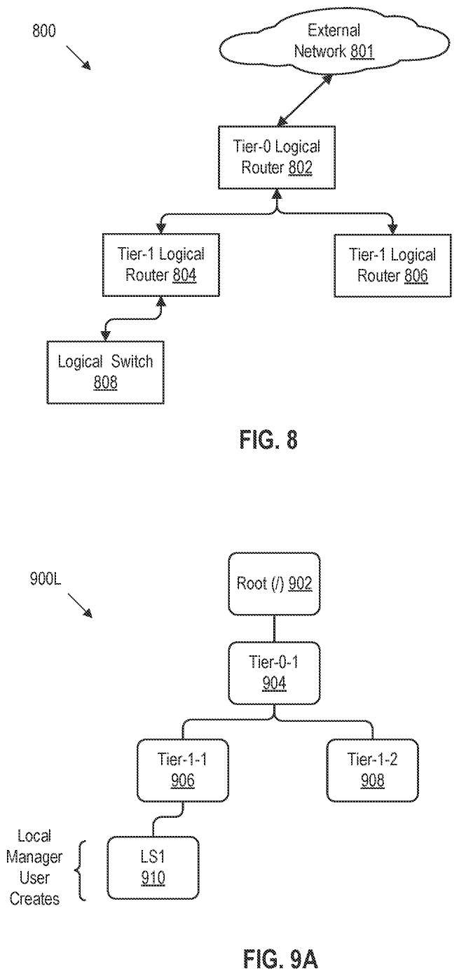

FIG. 8 is a block diagram depicting an SDN 800 according to an example. SDN 800 includes a tier-0 logical router 802 having its uplink port connected to an external network 801. SDN 800 includes two Tier-1 logical routers 804 and 806, each having a port connected to tier-0 logical router 802 (e.g., through a transit logical switch (not shown)). SDN 800 includes a logical switch 808 having a port connected to a port of tier-1 logical router 804.

FIG. 9A is a block diagram depicting an object hierarchy in an inventory of a local network manager according to an example. A local inventory 900L includes objects 902, 904, 906, 908, and 910 representing SDN entities in SDN 800 of FIG. 8. Object 902 is a root object. Object 904 represents tier-0 logical router 802. Object 906 represents tier-1 logical router 804. Object 908 represents tier-1 logical router 806. Object 910 represents logical switch 808. In the examples discussed below, assume a user of the local manager creates object 910 corresponding to logical switch 808.

FIG. 9B is a block diagram depicting an object hierarchy in inventory of a global network manager according to an example. A global inventory 900G includes objects 912, 920, 922, 904D, 906D, 908D, 914, 916, and 918. Object 912 is a root object. Object 920 represents an organization. Object 922 represents a project (e.g., the SDDC having the local manager). As discussed above, the path /org/project is the same as the root (/) of local inventory 900L. Object 904D is a discovered object representing tier-0 router 802. Object 906D is a discovered object representing tier-1 router 804. Object 908D is a discovered object representing tier-1 router 806. Object 916 represents a domain under the project. Object 918 represents a security policy under the project. Objects 916 and 918 are created in global inventory 900G, but not yet represented in local inventory 900L. A user of the global network manager creates object 914, representing logical switch 808, around the same time as the user of the local network manager created object 910 (before updates are exchanged).

In the example above, the global network manager sends updates to the local network manager for objects 916, 918, and 914. Each update indicates a create action. The local network manager sends an update to the global network manager for object 910, which indicates a create action. Local inventory 900L does not include objects matching objects 916 and 918. Thus, there is no conflict for updates with objects 916 and 918. The local network manager can create discovered objects for objects 916 and 918 in its object hierarchy so that those policies are applied to SDN 800.

Objects 914 and 910 can potentially apply different policies to logical switch 808 are thus in conflict in both the local and global inventories. Both the global network manager and the local network manager detect the conflict (step 522). The global network manager adds the update for object 910 to its sandbox (step 524) and generates an alarm. The local network manager adds the update for object 914 to its sandbox (step 524) and generates an alarm.

A user responds to the alarms by deleting an object from one of the local and global inventories. For example, a user can delete object 914 from global inventory 900G. In this case, the global network manager will detect the object deletion and resolve the conflicting update in the sandbox. The conflict resolution will result in creation of the object 910 as a discovered object in inventory 900G. The deletion of object 914 results in the global network manager sending an update for object 914 indicating a delete action to the local network manager. The local manager will detect a matching update in its sandbox (step 512) and remove the conflicting update from its sandbox (step 518).

Alternatively, a user can delete object 910 from local inventory 900L. In this case, the local network manager will detect the object deletion and resolve the conflicting update in the sandbox. The conflict resolution will result in creation of the object 914 as a discovered object in inventory 900L. The deletion of object 910 results in the local network manager sending an update for object 910 indicating a delete action to the global network manager. The global network manager will detect a matching update in its sandbox (step 512) and remove the conflicting update from its sandbox (step 518).

A method of managing conflicts between a first inventory of a first manager and a second inventory of a second manager is described. The first manager and the second manager manage entities in a computing system. The first manager receives, from the second manager, an update to be applied to the first inventory. The update comprises a first object, disposed in the second inventory, which applies a first policy to an entity in the computing system. The first manager detects a conflict with a second object disposed in the first inventory. The second object applies a second policy to the entity that conflicts with the first policy applied by the first object. The first manager adds, in response to the conflict, the update to a buffer. The first manager detects a resolution of the conflict in the first inventory caused by the second object. The first manager applies, in response to the resolution, the update from the buffer to the first inventory to represent, in the first inventory, that the first policy is applied to the entity.

The method improves the functionality of the computing system. If the conflict is not resolved by the method, two different policies are defined by two different managers for application to the entity and, after receiving updates from each other, neither manager can reconcile which policy should be applied. This can result in a security issue, for example, if one policy should be applied over another and detrimentally affect operation of the computing system. Instead, the method detects and resolves the conflict so that a consistent policy is applied to the entity. This improves the functioning of the computer system through resolution of the security issue, for example.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in userspace on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. In some cases, if and where relevant, “virtualized computing instance” can encompass both VMs and containers.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing conflicts between a first inventory of a first manager and a second inventory of a second manager, the first manager and the second manager managing entities in a computing system, the method comprising:
receiving, at the first manager from the second manager, an update to be applied to the first inventory, the update comprising a first object, disposed in the second inventory, which applies a first policy to an entity in the computing system;
detecting, by the first manager, a conflict with a second object disposed in the first inventory, the second object applying a second policy to the entity that conflicts with the first policy applied by the first object;
adding, in response to the conflict, the update to a buffer of the first manager;
detecting, by the first manager, a resolution of the conflict in the first inventory caused by the second object; and
applying, by the first manager in response to the resolution, the update from the buffer to the first inventory to represent, in the first inventory, that the first policy is applied to the entity.

2. The method of claim 1, wherein the resolution of the conflict in the first inventory comprises removal of the second object from an object hierarchy of the first inventory.

3. The method of claim 1, further comprising:
removing, by the first manager in response to the resolution, the update from the buffer.

4. The method of claim 1, further comprising:
receiving, at the first manager from the second manager, another update comprising a third object, disposed in the second inventory;
determining, at the first manager, a relation between the third object and the first object;
adding, in response to the conflict and the relation, the other update to the buffer of the first manager; and
applying, by the first manager in response to application of the update, the other update from the buffer to the first inventory.

5. The method of claim 1, wherein the first inventory includes a first object hierarchy, the second inventory includes a sub-tree representing the first object hierarchy, and a first path of the first object in the first object hierarchy matches a second path of the second object in the sub-tree.

6. The method of claim 1, further comprising:
generating, by the first manager, an alarm in response to adding the update to the buffer.

7. The method of claim 1, further comprising:
receiving, at the first manager from the second manager, another update comprising the first object, the other update indicating deletion of the first object from the first inventory; and
determining, by the first manager, that the buffer stores the update having the first object and, in response to the other update, deleting the update from the buffer.

8. The method of claim 1, further comprising:
receiving, at the first manager from the second manager, another update comprising the first object, the other update indicating that the first object applies a third policy to the entity in the computing system; and
determining, by the first manager, that the buffer stores the update having the first object and, in response to the other update, updating the first object to apply the third policy.

9. The method of claim 1, wherein the first manager is a global network manager executing in a public cloud of the computing system, wherein the first manager is a local network manager executing in a software-defined data center (SDDC) of the computing system, and wherein a software-defined network (SDN) of the SDDC includes the entity.

10. The method of claim 1, wherein the first manager is a local network manager executing in a software-defined data center (SDDC) of the computing system, wherein a software-defined network (SDN) of the SDDC includes the entity, and wherein the first manager is a global network manager executing in a public cloud of the computing system.

11. A non-transitory computer readable medium comprising instructions to be executed in a computing device to cause the computing device to carry out a method of managing conflicts between a first inventory of a first manager and a second inventory of a second manager, the first manager and the second manager managing entities in a computing system, the method comprising:
receiving, from the second manager, an update to be applied to the first inventory, the update comprising a first object, disposed in the second inventory, which applies a first policy to an entity in the computing system;
detecting a conflict with a second object disposed in the first inventory, the second object applying a second policy to the entity that conflicts with the first policy applied by the first object;
adding, in response to the conflict, the update to a buffer of the first manager;
detecting a resolution of the conflict in the first inventory caused by the second object; and
applying, in response to the resolution, the update from the buffer to the first inventory to represent, in the first inventory, that the first policy is applied to the entity.

12. The non-transitory computer readable medium of claim 11, further comprising:
receiving, from the second manager, another update comprising a third object, disposed in the second inventory;
determining a relation between the third object and the first object;
adding, in response to the conflict and the relation, the other update to the buffer of the first manager; and
applying, in response to application of the update, the other update from the buffer to the first inventory.

13. The non-transitory computer readable medium of claim 11, wherein the first manager is a global network manager executing in a public cloud of the computing system, wherein the first manager is a local network manager executing in a software-defined data center (SDDC) of the computing system, and wherein a software-defined network (SDN) of the SDDC includes the entity.

14. The non-transitory computer readable medium of claim 11, wherein the first manager is a local network manager executing in a software-defined data center (SDDC) of the computing system, wherein a software-defined network (SDN) of the SDDC includes the entity, and wherein the first manager is a global network manager executing in a public cloud of the computing system.

15. A computing system, comprising:
a first manager and a second manager executing on virtualized infrastructure (VI), the first and second managers managing entities in the VI;
a first inventory of the first manager; and
a second inventory of the second manager;
wherein the first manager is configured to:
receive, from the second manager, an update to be applied to the first inventory, the update comprising a first object, disposed in the second inventory, which applies a first policy to an entity in the computing system;
detect a conflict with a second object disposed in the first inventory, the second object applying a second policy to the entity that conflicts with the first policy applied by the first object;
add, in response to the conflict, the update to a buffer of the first manager;
detect a resolution of the conflict in the first inventory caused by the second object; and
apply, in response to the resolution, the update from the buffer to the first inventory to represent, in the first inventory, that the first policy is applied to the entity.

16. The computing system of claim 15, wherein the resolution of the conflict in the first inventory comprises removal of the second object from an object hierarchy of the first inventory.

17. The computing system of claim 15, wherein the first manager is configured to remove, in response to the resolution, the update from the buffer.

18. The computing system of claim 15, wherein the first manager is configured to:
receive, from the second manager, another update comprising a third object, disposed in the second inventory;
determine, a relation between the third object and the first object;
add, in response to the conflict and the relation, the other update to the buffer of the first manager; and
apply, in response to application of the update, the other update from the buffer to the first inventory.

19. The computing system of claim 15, wherein the first manager is a global network manager executing in a public cloud of the computing system, wherein the first manager is a local network manager executing in a software-defined data center (SDDC) of the computing system, and wherein a software-defined network (SDN) of the SDDC includes the entity.

20. The computing system of claim 15, wherein the first manager is a local network manager executing in a software-defined data center (SDDC) of the computing system, wherein a software-defined network (SDN) of the SDDC includes the entity, and wherein the first manager is a global network manager executing in a public cloud of the computing system.
